(19) United States
(12) Patent Application Publication
(10) Pub. No.: US 2011/0243435 A1
(43) Pub. Date: Oct. 6, 2011

(54) APPARATUS AND METHOD FOR COLOR DISTORTION CORRECTION OF IMAGE BY ESTIMATE OF CORRECTION MATRIX

(75) Inventors: Sangkeun LEE, Seoul (KR); Yun-Sang HAN, Seoul (KR); Seok-Han LEE, Seoul (KR); Jong-Soo CHOI, Seoul (KR)

(73) Assignee: Chung-Ang University Industry-Academy Cooperation Foundation, Seoul (KR)

(21) Appl. No.: 12/904,798

(22) Filed: Oct. 14, 2010

(30) Foreign Application Priority Data
Mar. 30, 2010 (KR) 10-2010-0028424

(51) Int. Cl. G06T 5/00; G06T 9/00

(52) U.S. Cl. 382/166

(57) ABSTRACT

Provided is an apparatus for correcting color distortion, including a color model generation unit configured to generate an original color model and a distortion color model, wherein the original color model includes colors which correspond to each coordinates of RGB color space and a lossy compression and color improvement operation are performed to the original color model to generate the distortion color model, a color space conversion unit configured to generate a converted original model and a converted distortion model by converting each value of the RGB color space included in the original color model and the distortion color model into color values of L*a*b* color space, a correction matrix computation unit configured to compute a correction matrix which converts each color value of the converted distortion model into each color value of the converted original model; and a color correction unit configured to correct color of a distortion image which is externally inputted by using the correction matrix.

### CROSS-REFERENCE TO RELATED APPLICATION

This application claims priority to Korean Patent Application No. 10-2010-0028424 filed on Mar. 30, 2010 and all the benefits accruing therefrom under 35 U.S.C. §119, the contents of which are incorporated by reference in their entirety.

### BACKGROUND

The present disclosure relates to a device and a method for correcting color distortion of an image by an estimate of a correction matrix, and inure particularly, to a device and a method for closely representing color of an original image by correcting color distortion generated during an image compression process.

Generally, image compression technology is classified into two categories, i.e., lossless image compression and lossy image compression. The former is a compression technique for compressing an image data without variation of original image color and is used for photographs, print media and medical images. The latter is a compression technique which loses some of original data.

Since the lossy image compression guarantees higher compression rate in comparison with the lossless image compression, it may be usefully applied to the World Wide Web (WWW) for fast transmission through the internet. Actually, many web sites such as YouTube, myspace (United States) and cyworld (Korea), which provide a video clip sharing service for web site users, compress images using the lossy compression technique. Also, a process for improving the contents of the video clip is performed. However, when the image data are processed by the compression or another operation of the sharing web sites, color information of the image is inevitably distorted.

FIG. 1 is a diagram illustrating an example of an image process by a sharing web site. Referring to FIG. 1, if an image photographed by a user is uploaded to the sharing web site, the sharing web site performs the lossy compression and color correction to the image through the image process. The compressed image passed through the image process is transferred to other users through the internet. Due to the lossy compression and color correction performed to the image by the sharing web site, the color of the original image is distorted.

Due to the image process illustrated in FIG. 1, the image shown through the internet has distorted color. FIG. 2 illustrates the original image and the compressed image for comparing their colors. In FIG. 2, the right-sided images are magnified images of respective portions of the left-sided images. In FIG. 2, (a) illustrates the original image and (b) illustrates the compressed image. Comparing the right-sided images of (a) and (b), it may be ascertained that the image information included in the original image is largely lost due to the image compression.

For overcoming the color distortion problem due to the image compression, the lossy compression techniques such as MPEG-x and H.26x have been studied for reducing data quantity as well as minimizing the color information loss. Also, researches have been made for correcting the color distortion or variation which includes directly generated distortion or variation due to the lossy compression.

A method of using a color chart has been proposed as one method for correcting the color distortion generated due to a camera setting, an environmental factor and ability of a user. However, this method has a problem of photographing an image which includes the color chart every time before the correction. Also, an automatic color transfer algorithm has been proposed. However, since this algorithm requires a reference image, it is difficult to correct to the color distortion generated due to the lossy compression.

Therefore, overcoming the above-mentioned problems, a method of simply correcting the image color distortion is needed so that it is unnecessary to repeatedly photograph a reference image every time correction is performed.

### SUMMARY

The present disclosure provides a device and a method for color distortion correction of an image by estimate of the correction matrix in order to simply correct color distortion of all the images without a reference color chart or a reference image.

The present disclosure also provides a computer readable medium which stores a program for operating a method for color distortion correction of an image by estimate of the correction matrix in order to simply correct color distortion of all the images without a reference color chart or a reference image.

According to an exemplary embodiment, an apparatus for correcting color distortion includes a color model generation unit configured to generate an original color model and a distortion color model, wherein the original color model includes colors which correspond to each coordinates of RGB color space and a lossy compression and color improvement operation are performed to the original color model to generate the distortion color model, a color space conversion unit configured to generate a converted original model and a converted distortion model by converting each value of the ROB color space included in the original color model and the distortion color model into color values of L*a*b* color space, a correction matrix computation unit configured to compute a correction matrix which converts each color value of the converted distortion model into each color value of the converted original model; and a color correction unit configured to correct color of a distortion image which is externally inputted by using the correction matrix.

According to another exemplary embodiment, a method of color distortion correction includes generating an original color model and a distortion color model, wherein the original color model comprises colors which correspond to each coordinates of RGB color space and a lossy compression and color improvement operation are performed to the original color model to generate the distortion color model; generating a converted original model and a converted distortion model by converting each value of the ROB color space comprised in the original color model and the distortion color model into color values of L*a*b* color space; computing a correction matrix which converts each color value of the converted distortion model into each color value of the converted original model; and correcting color of a distortion image which is externally inputted by using the correction matrix.

### BRIEF DESCRIPTION OF THE DRAWINGS

The patent or application file contains at least one drawing executed in color. Copies of this patent or patent application publication with color drawings(s) will be provided by the Office upon request and payment of the necessary fee. Exemplary embodiments can be understood in more detail from the following description taken in conjunction with the accompanying drawings, in which:

FIG. 1 is a diagram illustrating an example of an image process by a sharing web site;

FIG. 2 illustrates an original image and a compressed image for comparing their colors;

FIG. 3 is a block diagram illustrating a device for correcting an image color distortion by an estimate of a correction matrix according to a preferred embodiment of the present invention;

FIG. 4 is a diagram illustrating one example of an original color model and a distortion color model;

FIG. 5 is a flow chart illustrating a performing process of a color distortion correction method by the estimate of the correction matrix according to the preferred embodiment of the present invention;

FIG. 6 is a graph illustrating a color value difference between an original image and a distortion image and between the original image and a corrected image when the number of used correction matrices is 1 and 3;

FIG. 7 is a diagram illustrating a result after performing the color correction to given images;

FIG. 8 is a diagram illustrating a result after performing the color correction to images which have higher contrast than those of FIG. 7;

FIG. 9 is a diagram illustrating magnified portions of the original image, the distorted image and the corrected image;

FIG. 10 is a diagram illustrating color value differences measured from 50 test images before and after the correction;

FIG. 11 is a diagram illustrating the PSNR value measured from the 50 test images before and after the correction; and

FIG. 12 is a diagram illustrating a correction ratio measured from the 50 test images.

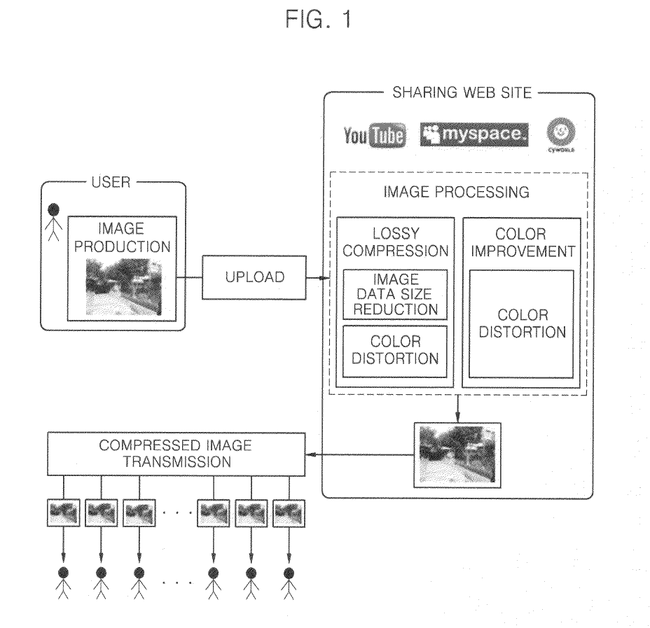

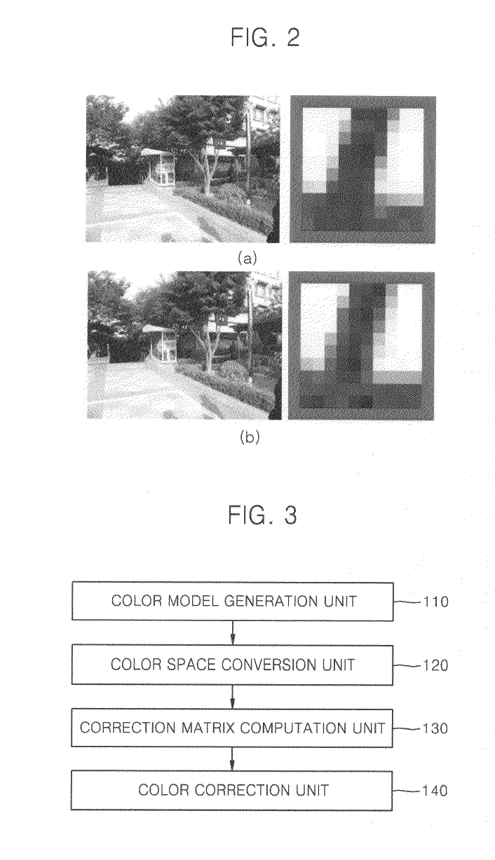

### DETAILED DESCRIPTION OF EMBODIMENTS

Hereinafter, specific embodiments will be described in detail with reference to the accompanying drawings.

FIG. 3 is a block diagram illustrating a device for correcting an image color distortion by an estimate of a correction matrix according to a preferred embodiment of the present invention.

Referring to FIG. 3, the color distortion correction device includes a color model generation unit 110, a color space conversion unit 120, a correction matrix computation unit 130 and a color correction unit 140.

The color model generation unit 110 generates an original color model and a distortion color model. The original color model includes colors which correspond to each coordinates of RGB color space. The distortion color model is generated by performing the lossy compression and color improvement operation to the original color model.

As above-explained, a sharing web site which provides various image contents performs image processes such as the lossy compression and color improvement operation to an uploaded image and provides the processed image to users through the internet. The color distortion correction device according to the present invention uses the original color model and the distortion color model in order to correct distorted color of the image passed through the above-mentioned image process.

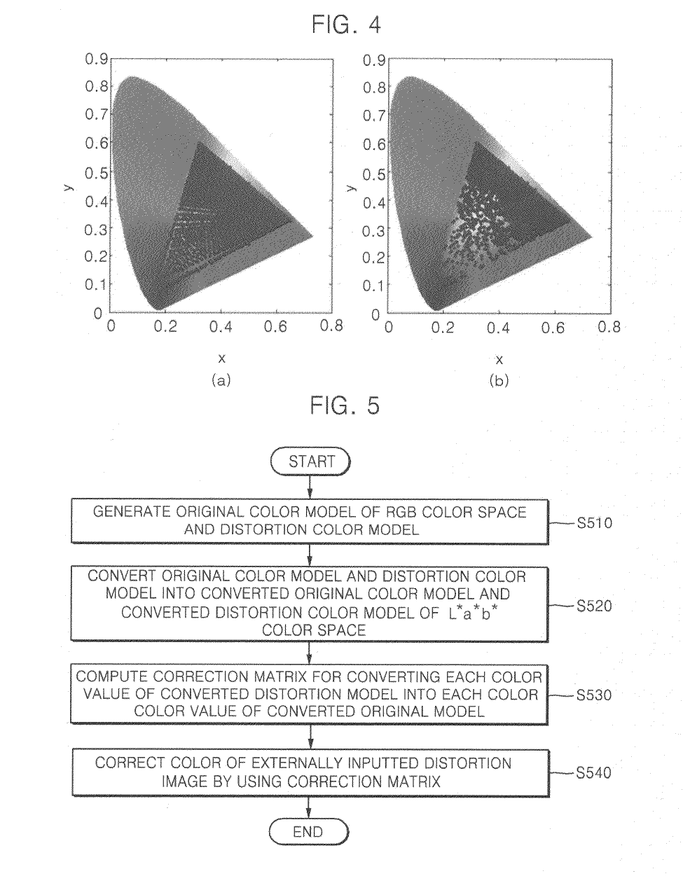

Therefore, the distortion color model is gained by performing the same operation as the image process performed by the sharing web site to the original color model. Also, it is desirable that the original color model includes all the color values of the RGB color space. As one embodiment, the original color model may be generated using a plurality of sample images. The sample images include various colors which correspond to different color values ranging from 0 to 255 of each channel of R, G and B. FIG. 4 is a diagram illustrating one example of the original color model and the distortion color model. In FIG. 4, (a) is the original color model and (b) is the distortion color model. They are shown in CIEXYZ color space. It may be ascertained that the color information is greatly distorted due to the image process performed by the sharing web site.

The color space conversion unit 120 generates a converted original model and a converted distortion model by converting each value of the RGB color space included in the original color model and the distortion color model to color values of L*a*b* color space.

The color distortion correction device according to the present invention computes a correction matrix for correcting colors of the distortion color model so that the distortion color model becomes the same as the original color model. By using the computed correction matrix, the color distortion correction device corrects the color of the image provided through the sharing web site. In order to compute the correction matrix, the original color model and the distortion color model which include the color values of the RGB color space are converted into the converted original model and the converted distortion model of the L*a*b* color space. Herein, the color space conversion is performed by using the CCIR recommendation 709 based on the CIE standard light source 1065, because the CIELab color space represents color in the same manner as a human sense, and precise and dense representation is possible at a low cost.

For converting the original color model and the distortion color model into the converted original model and the converted distortion model, tristimulus values are calculated corresponding to reference white color of the D65 light source. That is, R, G and B color values ranging from 0 to 255 are respectively converted into an X value ranging from 0 to 242.36628, a Y value ranging from 0 to 255.00 and a Z value ranging from 0 to 277.63228 according to following Equation (1).

$$[ \begin{matrix}X \\ Y \\ Z\end{matrix} ] = [ \begin{matrix}0.412453 & 0.357580 & 0.180423 \\ 0.212671 & 0.715160 & 0.072169 \\ 0.019334 & 0.119193 & 0.950227\end{matrix} ] [ \begin{matrix}R \\ G \\ B\end{matrix} ] \qquad ( 1 )$$

After the RGB color space is converted into the XYZ color space, the XYZ color space is converted into the L*a*b* color space by Equation (2) shown below.

$${L}^{*} = \{ \begin{matrix}116 {( \begin{matrix}Y \\ {Y}_{n}\end{matrix} )}^{\frac{1}{3}} - 16 if \frac{Y}{{Y}_{n}} > 0.008856 \\ 903.3 ( \begin{matrix}Y \\ {Y}_{n}\end{matrix} ) if \frac{Y}{{Y}_{n}} \leq 0.008856\end{matrix} \\ {a}^{*} = 500 ( f ( \frac{X}{{X}_{n}} ) - f ( \frac{Y}{{Y}_{n}} ) ) \\ {b}^{*} = 200 ( f ( \frac{Y}{{Y}_{n}} ) - f ( \frac{Z}{{Z}_{n}} ) ) \qquad ( 2 )$$

Herein, f(•) is defined as following Equation (3).

$$f ( t ) = \{ \begin{matrix}{t}^{\frac{1}{3}} if t > 0.008856 \\ 7.787 t + \frac{16}{116} if t \leq 0.008856\end{matrix} \qquad ( 3 )$$

The converted original model and the converted distortion model generated by respectively converting the original model and the distortion model are defined as an original image and a distortion image below in order to explain a computation process of the correction matrix.

The correction matrix computation unit 130 computes the correction matrix which converts each color value of the converted distortion model into each color value of the converted original model.

However, even if fairly good result may be obtained by correcting the distortion image by a single correction matrix, a region of very high or low color value may not be properly corrected. Therefore, the correction matrix computation unit 130 may classify the color values included in the converted distortion model and the converted original model into a plurality of regions, e.g., a very dark portion, a normally bright portion and a very bright portion. Then, the correction matrix computation unit 130 may compute correction matrices which correspond to each region.

Although the conversion between the original image and the distortion image is not an exact linear relation, the correction matrix is estimated as following Equation (4) on the assumption that the conversion is linear.

$$\begin{matrix}{M}_{{L}^{*} {a}^{*} {b}^{*}} = {M}_{c} {M}_{{L}^{*} {a}^{*} {b}^{*}}^{′} \\ = [ \begin{matrix}{L}_{1}^{*} & {L}_{2}^{*} & & {L}_{N}^{*} \\ {a}_{1}^{*} & {a}_{2}^{*} & … & {a}_{N}^{*} \\ {b}_{1}^{*} & {b}_{2}^{*} & & {b}_{N}^{*}\end{matrix} ] \\ = [ \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ] [ \begin{matrix}{L}_{C 1}^{*} & {L}_{C 2}^{*} & & {L}_{CN}^{*} \\ {a}_{C 1}^{*} & {a}_{C 2}^{*} & … & {a}_{CN}^{*} \\ {b}_{C 1}^{*} & {b}_{C 2}^{*} & & {b}_{CN}^{*}\end{matrix} ]\end{matrix} \qquad ( 4 )$$

Herein, M_{L*a*b*} is a 3×N matrix which corresponds to the original image, M′_{L*a*b *}is a 3×N matrix which corresponds to the distortion image, and M_{C} is a 3×3 correction matrix for mapping each color value of the distortion image to each color value of the original image. (L*ᵢ, a*ᵢ, b*ᵢ) is a color value which corresponds to an iₜₕ pixel of the original image, and (L*_{Ci}, a*_{Ci}, b*_{Ci}) is a color value which corresponds to an iₜₕ pixel of the distortion image.

Equation (4) may be expressed as a linear equation to each column of the correction matrix M_{C} as shown in following Equations (5) to (7).

$$\begin{matrix}\begin{matrix}{P}_{( 1 )} = {M}_{{L}^{*} {a}^{*} {b}^{*}}^{′} \cdot {m}_{( 1 )} \\ = [ \begin{matrix}{f ( {L}^{*} , {a}^{*} , {b}^{*} )}_{( 1 ) 1} \\ {f ( {L}^{*} , {a}^{*} , {b}^{*} )}_{( 1 ) 2} \\ ⋮ \\ {f ( {L}^{*} , {a}^{*} , {b}^{*} )}_{( 1 ) N}\end{matrix} ] \\ = [ \begin{matrix}{L}_{1}^{*} \\ {L}_{2}^{*} \\ ⋮ \\ {L}_{N}^{*}\end{matrix} ] \\ = [ \begin{matrix}{L}_{C 1}^{*} & {a}_{C 1}^{*} & {b}_{C 1}^{*} \\ {L}_{C 2}^{*} & {a}_{C 2}^{*} & {b}_{C 2}^{*} \\ ⋮ & ⋮ & ⋮ \\ {L}_{CN}^{*} & {a}_{CN}^{*} & {b}_{CN}^{*}\end{matrix} ] [ \begin{matrix}{m}_{11} \\ {m}_{12} \\ {m}_{13}\end{matrix} ]\end{matrix} & ( 5 ) \\ \begin{matrix}{P}_{( 2 )} = {M}_{{L}^{*} {a}^{*} {b}^{*}}^{′} \cdot {m}_{( 2 )} \\ = [ \begin{matrix}{f ( {L}^{*} , {a}^{*} , {b}^{*} )}_{( 2 ) 1} \\ {f ( {L}^{*} , {a}^{*} , {b}^{*} )}_{( 2 ) 2} \\ ⋮ \\ {f ( {L}^{*} , {a}^{*} , {b}^{*} )}_{( 2 ) N}\end{matrix} ] \\ = [ \begin{matrix}{a}_{1}^{*} \\ {a}_{2}^{*} \\ ⋮ \\ {a}_{N}^{*}\end{matrix} ] \\ = [ \begin{matrix}{L}_{C 1}^{*} & {a}_{C 1}^{*} & {b}_{C 1}^{*} \\ {L}_{C 2}^{*} & {a}_{C 2}^{*} & {b}_{C 2}^{*} \\ ⋮ & ⋮ & ⋮ \\ {L}_{CN}^{*} & {a}_{CN}^{*} & {b}_{CN}^{*}\end{matrix} ] [ \begin{matrix}{m}_{21} \\ {m}_{22} \\ {m}_{23}\end{matrix} ]\end{matrix} & ( 6 ) \\ \begin{matrix}{P}_{( 3 )} = {M}_{{L}^{*} {a}^{*} {b}^{*}}^{′} \cdot {m}_{( 3 )} \\ = [ \begin{matrix}{f ( {L}^{*} , {a}^{*} , {b}^{*} )}_{( 3 ) 1} \\ {f ( {L}^{*} , {a}^{*} , {b}^{*} )}_{( 3 ) 2} \\ {f ( {L}^{*} , {a}^{*} , {b}^{*} )}_{( 3 ) N}\end{matrix} ] \\ = [ \begin{matrix}{b}_{1}^{*} \\ {b}_{2}^{*} \\ ⋮ \\ {b}_{N}^{*}\end{matrix} ] \\ = [ \begin{matrix}{L}_{C 1}^{*} & {a}_{C 1}^{*} & {b}_{C 1}^{*} \\ {L}_{C 2}^{*} & {a}_{C 2}^{*} & {b}_{C 2}^{*} \\ ⋮ & ⋮ & ⋮ \\ {L}_{CN}^{*} & {a}_{CN}^{*} & {b}_{CN}^{*}\end{matrix} ] [ \begin{matrix}{m}_{31} \\ {m}_{32} \\ {m}_{33}\end{matrix} ]\end{matrix} & ( 7 )\end{matrix}$$

For solving this linear least square problem, a Singular Value Decomposition (SVD) may be used. If the relation M′_{L*a*b*}·m₍ᵢ₎=P₍ᵢ₎ is considered as Ax=b using m×n matrix A, the matrix A is decomposed as following equation (8) by the SVD.

A=UDV^{T} (8)

Herein, U and V are respectively m×m and m×n orthogonal matrices, and D is an m×n diagonal matrix. The matrix D includes descending peculiar values as shown in following equation (9).

d₁>d₂> . . . dᵢ, i≦min(m,n) (9)

Herein, a 3×3 correction matrix may be gained.

Meanwhile, if Equation (4) has a perfect solution, a residual error of Equation (6) is 0. That is, since the conversion between the original image and the distortion image is not exactly linear, a matrix which has a minimum residual error is needed. To this end, the Newton iteration method is used in order to minimize the residual error when the correction matrix is computed.

The residual error of Equation (4) is expressed as following Equation (10).

εₖⁱ=M′_{L*a*b*}^{T}·mₖⁱ−Pₖⁱ, k=1, 2, 3 (10)

Herein, εₖⁱ is a residual error of kₜₕ column vector at iₜₕ iteration. mₖⁱ is the kₜₕ column vector at the iₜₕ iteration of the correction matrix. Pₖⁱ represents each channel color value of the original image at the iₜₕ iteration.

A 3×3 matrix which includes parameter values for a next iteration is estimated as following Equation (11) from the residual error of Equation (10).

Δₖⁱ=−Jₖ⁺ⁱεₖⁱ (11)

Herein, J⁺ represents a 3×N pseudo-inverse matrix of a Jacobian matrix for each of Equations (5) to (7). The color value of the original image for a next iteration is estimated by following Equation (12).

Pₖⁱ⁺¹=Pₖⁱ+Δₖⁱ (12)

This process is repeated until the residual error is smaller than a predetermined error as shown in following Equation (13).

∥εₖⁱ+JₖⁱΔₖⁱ∥<ε′ (13)

The color correction unit 140 corrects color of the distortion image which is received from the outside by using the correction matrix.

After the correction matrix computation unit 130 computes the correction matrix, which converts the distortion image into the original image, according to the linear least square and optimizes it according to the Newton iteration method, the color correction unit 140 may use the correction matrix in order to correct color of the image provided from the sharing web site. At this time, since additional information about the received image is not needed, color of various images may be last corrected by using a single correction matrix.

FIG. 5 is a flow chart illustrating a performing process of a color distortion correction method by the estimate of the correction matrix according to the preferred embodiment of the present invention.

Referring to FIG. 5, in operation 5510, the color model generation unit 110 generates the original color model and the distortion color model. Herein, the original color model includes colors which correspond to each coordinates of the RGB color space, and the distortion color model is generated by performing the lossy compression and color improvement operation to the original color model. Next, in operation S520, the color space conversion unit 120 generates the converted original model and the converted distortion model by converting each value of the RGB color space included in the original color model and the distortion color model to color values of the L*a*b* color space.

In operation 5530, the correction matrix computation unit 130 computes the correction matrix which converts each color value of the converted distortion model into each color value of the converted original model. At this time, on the assumption that the relation between the converted distortion model and the converted original model is linear, the correction matrix may be computed through the linear least square method. Also, the correction matrix is optimized according to the Newton iteration method.

Finally, in operation 5540, the color correction unit 140 corrects color of the distortion image which is received from the outside by using the correction matrix.

An experiment has been conducted for testing performance of the present invention. For the experiment, 10 sample images and 50 test images have been used. Herein, the sample images have been manually manufactured and the test images have been taken by a digital camera. The test images have been distorted through the YouTube web site.

For computing the correction matrix, the original color model has been generated by using the 10 sample images which include all the color values of 8-bit RGB color space, and the distortion color model has been generated based on distorted images which correspond to the sample images. Herein, the distorted images have been gained through the web site. Next, the correction matrix has been estimated from the original color model and the distortion color model.

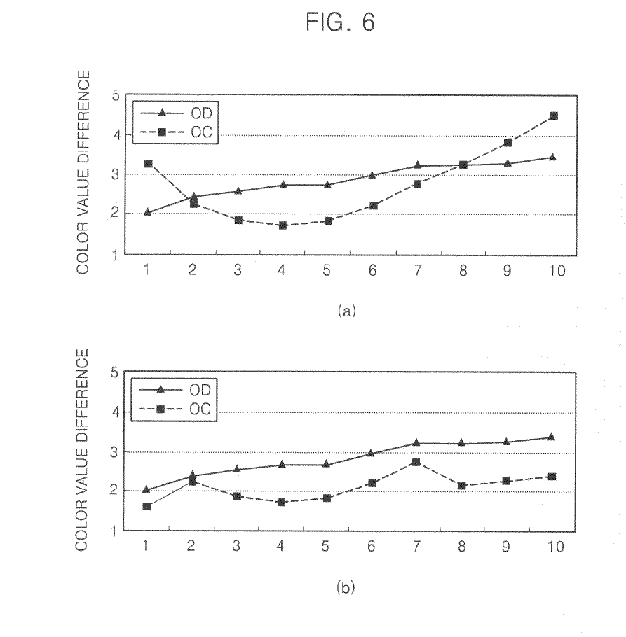

An experiment has been conducted for testing correction performance according to the number of used correction matrices. FIG. 6 is a graph illustrating a color value difference between the original image and the distortion image and between the original image and the corrected image when the number of used correction matrices is 1 and 3. The color correction has been performed to the given distorted images by using a single correction matrix firstly, and for comparison, the color correction has been performed by using three correction matrices.

Referring to (a) of FIG. 6, comparing the color value difference (OD) between the original image and the distortion image with the color value difference (OC) between the original image and the corrected image, there exists a period where the color value difference becomes even larger after the color correction. Therefore, it is ascertained that a single correction matrix is not enough for obtaining a satisfactory result. On the contrary, referring to (b) of FIG. 6, as a result of using three correction matrices for correcting color of the original image, the color value difference is reduced on all occasions.

For a quantitative performance test of the present invention, a color correction ratio and a Peak Signal-to-Noise Ratio (PSNR) have been computed. Firstly, the color correction ratio is defined as following Equation (14).

$$ζ = \frac{Δ {E}_{dist} - Δ {E}_{cor}}{Δ {E}_{dist}} \times 100 \qquad ( 14 )$$

Herein, ΔE_{dist} and ΔE_{cor} respectively represent an average of the color value difference between the original image and the distorted image and an average of the color value difference between the original image and the corrected image, and they are respectively computed by following Equations (15) and (16).

$$\begin{matrix}Δ {E}_{cor} = \frac{1}{N} {\sum }_{i = 1}^{N} \vert {R}_{ori}^{i} - {R}_{cor}^{i} \vert + \vert {G}_{ori}^{i} - {G}_{cor}^{i} \vert + \vert {B}_{ori}^{i} - {B}_{cor}^{i} \vert & ( 15 ) \\ Δ {E}_{dist} = \frac{1}{N} {\sum }_{i = 1}^{N} \vert {R}_{ori}^{i} - {R}_{dist}^{i} \vert + \vert {G}_{ori}^{i} - {G}_{dist}^{i} \vert + \vert {B}_{ori}^{i} - {B}_{dist}^{i} \vert & ( 16 )\end{matrix}$$

Herein, (Rₒᵣᵢ, Gₒᵣᵢ, Bₒᵣᵢ), (R_{dist}, G_{dist}, B_{dist}) and (R_{cor}, G_{cor}, B_{cor}) respectively represents the original image, the distortion image and the RGB color value of the corrected image. N is the number of whole pixels of the given image.

Next, PSNR is measured by following Equation (17).

$$PSNR = 10 \cdot {log}_{10} ( \frac{{MAX}^{2}}{MSE} ) = 20 \cdot {log}_{10} ( \frac{MAX}{\sqrt{MSE}} ) \qquad ( 17 )$$

Herein, MAX is a maximum pixel value (255) of the 8-bit input image, and MSE is a mean squared error.

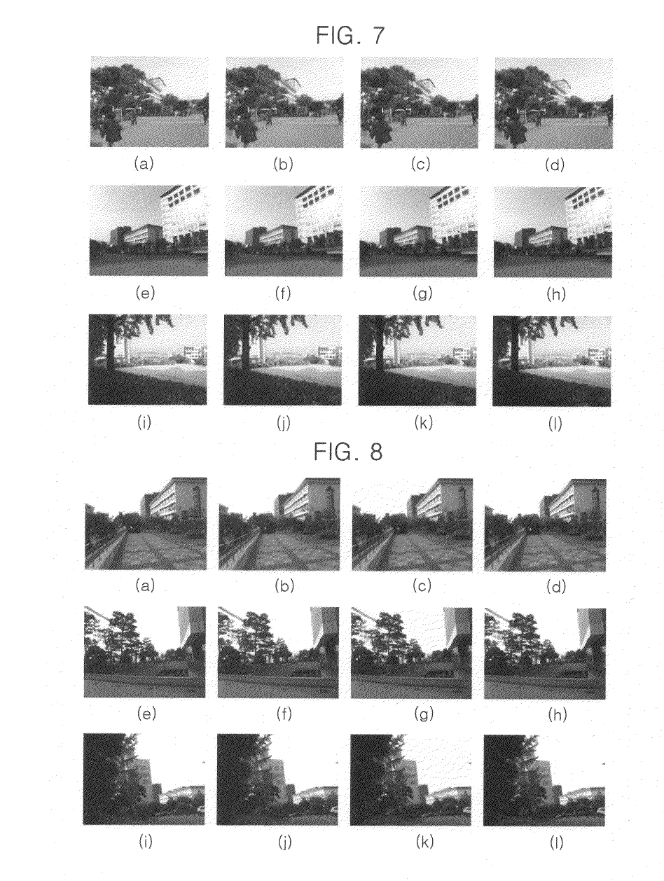

FIG. 7 is a diagram illustrating a result after performing the color correction to given images. FIG. 8 is a diagram illustrating a result after performing the color correction to images which have higher contrast than those of FIG. 7. In FIGS. 7 and 8, original images, distorted images, corrected images by one correction matrix and corrected images by three correction matrices are arranged from left to right. As shown, color of the distorted images is fairly corrected by using one matrix; however, the distorted images are better corrected and closer to the original images by using three correction matrices.

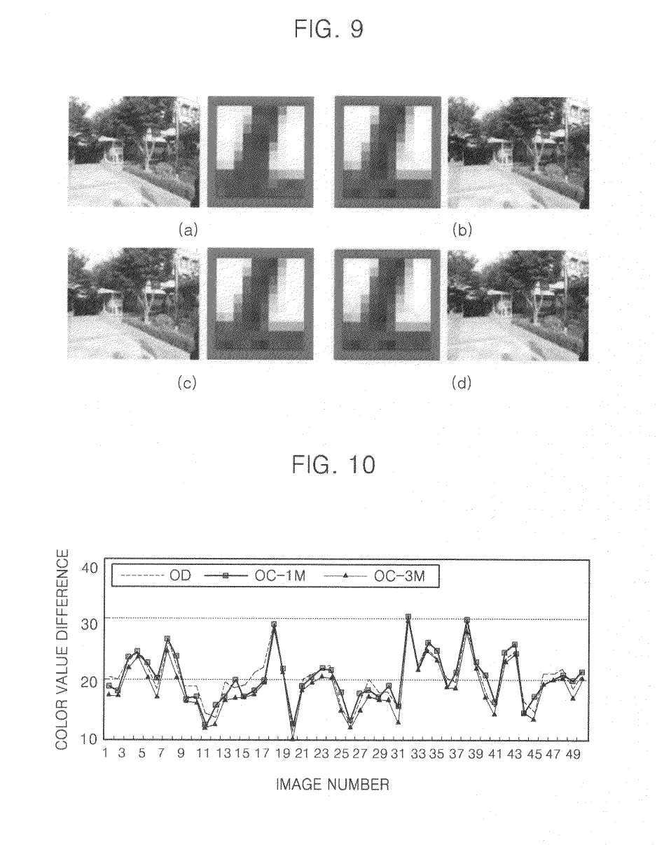

FIG. 9 is a diagram illustrating magnified portions of the original image, the distorted image and the corrected image. (a) is the original image, (b) is the distorted image by the sharing web site, (c) is the corrected image by using one correction matrix, and (d) is the corrected image by using three correction matrices. By magnifying the images, it is ascertained that the color distortion due to the compression is corrected to be close to the original image.

Following Table. 1 shows color correction ratios of the images of FIG. 8.

TABLE 1

| | Correction ratio (%) of | Correction ratio (%) of |
|---|---|---|
| Row number | one matrix | three matrices |
| 1 | −10.8452 | 4.5718 |
| 2 | −11.9565 | 5.3981 |
| 3 | −17.5804 | 6.6795 |
| Average of 50 | 1.2447 | 7.7848 |
| test images | | |

In Table. 1, higher correction ratio means better performance. Referring to Table. 1, when only one correction matrix is used for the image which has high contrast, the color distortion becomes even worse after the correction. However, in the case of using three correction matrices, the performance of color correction is improved. Particularly, in the case of using three correction matrices, the average color improvement ratio for the 50 test images is about 8% showing higher performance than using one correction matrix.

FIG. 10 is a diagram illustrating color value differences measured from the 50 test images before and after the correction. OD is the color value difference between the original image and the distortion image, OC-1M is the color value difference between the original image and the corrected image in the case of using one correction matrix, and OC-3M is the color value difference between the original image and the corrected image in the case of using three correction matrices. Referring to FIG. 10, in comparison with the case of non-correction, the color value difference from the original image is reduced in the case of correcting the color distortion. Particularly, the reduction is more noticeable in the case of using three correction matrices. Meanwhile, an average of the color value difference gained after performing the color correction to the 50 test images is about 1.54.

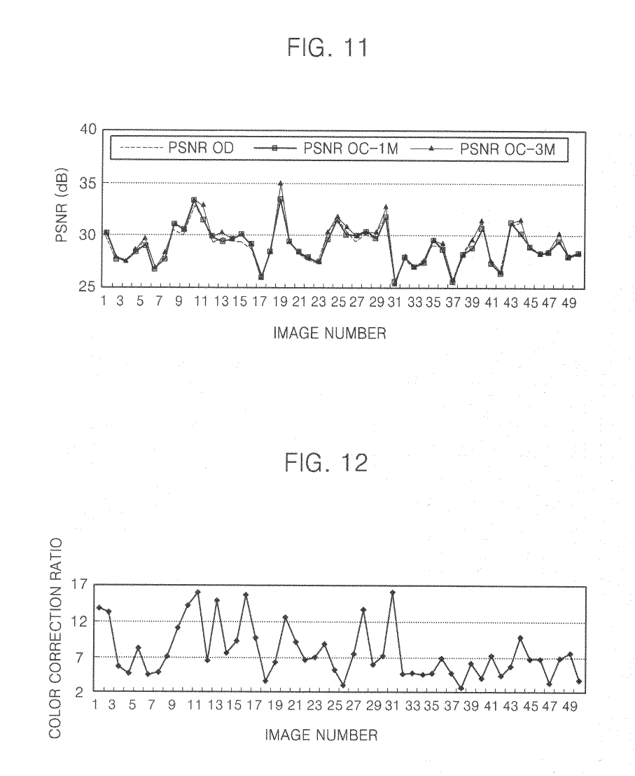

FIG. 11 is a diagram illustrating the PSNR value measured from the 50 test images before and after the correction. Although there is a period where the PSNR value variance is not large according to the images, the PSNR value generally becomes high after the color correction. An average of the PSNR value of the 50 test images is about 0.38 dB. FIG. 12 is a diagram illustrating a correction ratio measured from the 50 test images. An average of the correction ratio of the 50 test images is about 7.78%.

According to the above-mentioned quantitative result, it is ascertained that the present invention reduces the color distortion by using a pre-computed correction matrix without collecting additional information about the given image and makes the given image be close to the original image by correcting the given image.

It is possible to embody the present invention as a computer readable code in a computer readable recording medium. The computer readable recording medium includes all kinds of recording devices which store computer readable data. For instance, the computer readable recording medium includes ROM, RAM, CD-ROM, magnetic tape, floppy disk, optical data storage device and the like. Also, it may be also embodied as a carrier wave, e.g. transmission through the internet. The computer readable medium may be distributed to a network-connected computer system so that the computer readable code may be stored and operated.

According to the device and method for color distortion correction of an image by estimate of the correction matrix, the correction matrix for converting the distortion color model into the original color model is generated by using the original color model, which includes all the color values of the ROB color space, and the distortion color model which is generated by performing the same operation to the original color model as the image compression operation used in the sharing web site. Therefore, distorted color of all the images provided through the sharing web site can be effectively corrected. Also, since additional reference image or chart is not needed whenever the image is corrected, the correction process can be performed fast and simply.

Although the apparatus and method for color distortion correction of an image by estimate of the correction matrix have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. An apparatus for correcting color distortion, comprising:
a color model generation unit generating an original color model and a distortion color model, wherein the original color model comprises colors which correspond to each coordinates of RGB color space and a lossy compression and color improvement operation are performed to the original color model to generate the distortion color model;
a color space conversion unit generating a converted original model and a converted distortion model by converting each value of the RGB color space comprised in the original color model and the distortion color model into color values of L*a*b* color space;
a correction matrix computation unit computing a correction matrix which converts each color value of the converted distortion model into each color value of the converted original model; and
a color correction unit correcting color of a distortion image which is externally inputted by using the correction matrix.

2. The apparatus of claim 1, wherein the original color model comprises RGB color values which are comprised in pre-stored plural sample images.

3. The apparatus of claim 1, wherein the distortion color model is gained by performing the same operation to the original color model as the image process operation for compression transmission through the internet.

4. The apparatus of claim 2, wherein the distortion color model is gained by performing the same operation to the original color model as the image process operation for compression transmission through the internet.

5. The apparatus of claim 1, wherein the correction matrix computation unit classifies the color values comprised in the converted distortion model and the converted original model into a plurality of regions according to a predetermined reference color value, and respectively computes the correction matrix corresponding to each region.

6. The apparatus of claim 2, wherein the correction matrix computation unit classifies the color values comprised in the converted distortion model and the converted original model into a plurality of regions according to a predetermined reference color value, and respectively computes the correction matrix corresponding to each region.

7. The apparatus of claim 1, wherein the correction matrix computation unit computes the correction matrix by linear least square method on the assumption that conversion relation between each color value of the converted distortion model and each color value of the converted original model is linear.

8. The apparatus of claim 2, wherein the correction matrix computation unit computes the correction matrix by linear least square method on the assumption that conversion relation between each color value of the converted distortion model and each color value of the converted original model is linear.

9. A method of color distortion correction, comprising:
generating an original color model and a distortion color model, wherein the original color model comprises colors which correspond to each coordinates of RGB color space and a lossy compression and color improvement operation are performed to the original color model to generate the distortion color model;
generating a converted original model and a converted distortion model by converting each value of the RUB color space comprised in the original color model and the distortion color model into color values of L*a*b* color space;
computing a correction matrix which converts each color value of the converted distortion model into each color value of the converted original model; and
correcting color of a distortion image which is externally inputted by using the correction matrix.

10. The method of claim 9, wherein the original color model comprises RGB color values which are comprised in pre-stored plural sample images.

11. The method of claim 9, wherein the distortion color model is gained by performing the same operation to the original color model as the image process operation for compression transmission through the internet.

12. The method of claim 10, wherein the distortion color model is gained by performing the same operation to the original color model as the image process operation for compression transmission through the internet.

13. The method of claim 9, wherein the color values comprised in the converted distortion model and the converted original model are classified into a plurality of regions according to a predetermined reference color value, and the correction matrix is respectively computed corresponding to each region at the step of computing the correction matrix.

14. The method of claim 10, wherein the color values comprised in the converted distortion model and the converted original model are classified into a plurality of regions according to a predetermined reference color value, and the correction matrix is respectively computed corresponding to each region at the step of computing the correction matrix.

15. The method of claim 9, wherein the correction matrix is computed by linear least square method on the assumption that conversion relation between each color value of the converted distortion model and each color value of the converted original model is linear at the step of computing the correction matrix.

16. The method of claim 10, wherein the correction matrix is computed by linear least square method on the assumption that conversion relation between each color value of the converted distortion model and each color value of the converted original model is linear at the step of computing the correction matrix.

17. A computer readable recording medium which stores a program for operating the color distortion correction method of claim 9.
